(19) United States
(12) Patent Application Publication
(10) Pub. No.: US 2003/0133628 A1
(43) Pub. Date: Jul. 17, 2003

(54) Method and system by using the internet to offer the human synthesis modeling

(76) Inventor: Dong-Kwang Lee, Youngju-city (KR)

Correspondence Address: Paul J. Farrell, Esq., DILWORTH & BARRESE, LLP, 333 Earle Ovington Blvd., Uniondale, NY, 11553, US

(21) Appl. No.: 10/328,959

(22) Filed: Dec. 24, 2002

Related U.S. Application Data
(63) Continuation of application No. PCT/KR00/00777, filed on Jul. 18, 2000.

(30) Foreign Application Priority Data
Jun. 26, 2000 (KR) 2000/35417

(51) Int. Cl. G06K 9/03; G06F 15/16

(52) U.S. Cl. 382/309; 709/201

(57) ABSTRACT

This invention enables the user to synthesize the human body synthesis by simply working on the digital image picture displayed on the monitor of the computer connected on the Internet to the server system which has the human body synthesis program or provides the human body synthesis service, being linked with the human body synthesis database where various contents are stored, and enables the server system, which provides the human body synthesis service, being linked with the computer on the Internet, to provide various contents on-line necessary for the human body synthesis, enabling the user to produce various images.

### FIELD OF THE INVENTION

This invention is based on the method and system through the internet technology to offer human synthesis modeling. In detail, the main server connected to internet will provide to users variety of contents of human synthesis modeling which is itemized and constructed on client system database and can be up-dated.

This method and system is internet based human synthesis modeling that the users will connect to internet server or the human synthesis contents database of client system of computer or kiosk system that has human synthesis application program, which the users will work on and synthesize.

### BACKGROUND OF THE TECHNOLOGY

Modern society is generally known as information technology and internet era through the digital revolution that created an information-oriented society and users gather information through the personal computer and the mobile phone services.

The internet originally invented for the purpose of military use but recently the internet is not for the use of any special field, it became part of our daily life and internet users have grown rapidly. Since rapid growth of internet users, the contents providers are also increasing fast.

On the Internet there are variety of information providers, each has their own specialties and World Wide Web is especially popular among the users. World Wide Web is most popular worldwide because it is convenient to use and on the Internet it creates multimedia function, which differs from others. In the beginning it depended only on text information but these days all kinds of graphic and real time image services that provides multimedia function for users.

On the other hand, computer system and software technology have expanded and developed rapidly. At present time, people would like to create self-image that makes distinction from others. People strive to express distinctive personality, for that, people use scanner or digital camera to display self-portrait on the computer and do the make-ups, hair styling and put accessories on their image before they actually do the job.

For this distinctive image creation, there are two-dimensional portrait image compiling programs have been developed.

Image compiling programs for the computer, Adobe Company developed a product known as ‘Photo-Shop’ for the Macintosh and IBM, Aldus Company's ‘Photo-Styler’ for IBM and Fractal Design Company's ‘Color-Studio’.

These image compiling programs are difficult to work on for the users when they input scanned image or using digital camera, one should know methods of composing tools. The image processing program experts are the only ones who can work on image mixing and editing. General users need professional technique to work with these tools; therefore for the practical use it takes great deal of time and budget. The problems of these tools are even for the experts; one should work on filtering job one by one in detail, which is time-consuming job.

Using image-processing program, current image composing tools need object images such as photos of model, editable essential elements such as hairstyle, accessories, make-ups etc. and other variety of contents should be prepared. Up to now users prepared needed contents separately, which took time and budget. In reality it is difficult to secure the variety of contents that users planed image mixing works are restricted which is the problems of tools.

All these complicated image processing program tools, a simple tool is necessary for the users and a tool that users can mix and edit their digital portrait picture displayed on the monitor without any expert knowledge or technique. And kiosk system or computers of users that is connected to online internet so that one can easily access needed modeling contents and work on real time image mixing and editing that user can see the effects of their image without waiting to render.

### DETAIL DESCRIPTION OF PREFERRED EMBODIMENT

The formation of this invention explains through attached drawing, this drawing is only concrete illustration of example explanation that does not mean there is any restriction or limitation.

FIG. 1 is entire block drawing of formation of this invention.

When a user strives to receive services of the presented drawing formation of invention the following devices are needed; control device (11), input device (12), output device (13), database (14), image in and output devices (15), database management device (16), database update device (17), browser (18), communication device (19) all these devices are constructed as client system (10), link device (22), member certification device (23), system management device (24) and these devices are constructed as web server device (21), member information database (26), contents database (27) and these are finally constructed as database server (25) and become server system (20).

Client system device (10) is consisted of control device (11), input device (12), output device (13), database (14), image in and output devices (15), database management device (16), database update device (17), browser (18), communication device (19). Control device (11) can be connected to computer peripheral devices and controls peripherals. The function of control device (11) of this invention is to provide services for the displayed digital portrait image on the monitor to synthesize through set up of the human synthesis application device on input device (11) that users can work on input image information from database (11), and through the browser it connects to server system device (20) which provides variety of necessary human synthesis contents from database update device (20) and stores on database (14).

The input device (12) is to use actual photo of digital camera or scanner and display the portrait image on the computer monitor, users can operate using the portrait image input method and keyboard or mouse on displayed image to synthesize the image and input.

The output device (13) is to use portrait image input method of input device (12) that designated temporary data to storage device to store and displays on the monitor through control device (11) that users can work on human synthesis, when job is done it can be printed on computer printer or photo printer.

Database (14) is to use when users work on human synthesis, client system device (10) will provide the contents through the internet. In order to provide the contents on the internet the client system device (10) will classify the items and fields. In general the client system device (10) has portrait of targeted model for the synthesis and variety of images such as hairstyle, accessories, clothes, etc. to classify the data and itemize for synthesis. Based on these itemized data, the input image information to real time image mixing is possible and server system device (20) updates the contents. The contents will be inputted to server system device (20) through the browser device (18) and the database management device (16) will classify each field and store them on database (14).

The database management device (16) classifies necessary contents by items and fields from server system device (20) which transmitted through the internet and store the contents on database (14) or when users want to work on human synthesis, needed contents can be outputted from database management device (16).

The database update device (17) updates data through the browser device (18) which transmitted from internet connected server system device (20) and through the database management device (16), it classifies the data by items and fields then stores up on database (14).

The portrait image input and output devices (15) is when users output stored portrait image from database that have cognizance of image on user's monitor and necessary image data for the synthesis work can be inputted with a fixed formation on database.

The browser device (18) searches contents of all the files on internet that users can have cognizance of content to display on monitor and input necessary contents of human synthesis that transmitted from server system device (20) and through the database updated device (17) to store on database (14).

The communication device (19) includes modem, ADSL, IDSN and LAN which client system device (10) and server system device (10) can transmit and receive the data each other.

The server system device (20) is constructed of web server device (21) and database server device (25) that is web server device (21) is constructed of link device (22), member certification device (23), system management device (24) and users connect to link device (22) of web server device (21) using browser device (18) then member certification device (23) will identify whether the member is authorized to work through the member information database device (26) of database server device (25). System management device (24) inputs user's command that is transmitted through browser device (18) and execute the command with ASP (Active Server Pages), CGI (Common Gateway Interface) script to run on internet web to provide service for human synthesis work. This is to expand function of web server to run script and approach database of database server device (25) and process function to control extract related command data and input the data to store or delete the data.

The web server device (21) works on updated and stored contents of contents database device (27) of database server device (25) when related updated contents to transmit client system device (10) through online.

The database server device (25) is constructed with member information database device (26) and contents database device (27). Member information database device (26) is when users connected to web server device (21) through internet, they are provided services of this invention and identifies the connected user whether the user is a member. Web server device (21) stores information of members to identify. Contents database device (27) stores necessary human synthesis data to index and classifies by items and fields, when users connected through internet on web server device (21) to work on human synthesis to run on real time.

The user of client system device (10) is to have services of this invention that provides. Users can work on client system device (10) itself to synthesize the human synthesis and also users can be provided services of human synthesis from internet connected web server device (21). In case the client system device (10) itself works on human synthesis, internet connected server system device (20) will renew necessary contents for human synthesis that updates additional factors when it happens.

Human synthesis contents services provided by this invention, the desirable management of services will be membership and when human synthesis work takes place on client system device (10), install the human synthesis application program on client system device (10) through CD-ROM or download the application program from web server device (21) then install it on client system device (10). Renewed contents on the web server device (21) updates transmitted renew data on database (14) of client system device (10) when client system device (10) is online situation.

The client system device (10) that executes human synthesis of this invention can utilize and work on personal computer connected to internet. Usually it is recommendable that as a sticker photo equipment, set tip a computer at certain place and install human synthesis application program on the computer. Index all necessary contents to classify by items and fields so that when users want to use data of contents, it can be provided through online like kiosk system that is recommendable to work on human synthesis. When establish a characteristic kiosk system it is desirable to have membership and non membership services in different grade.

Basically, using personal computer or kiosk system, program can be executed through client system device (10) of this invention that when users search or select from database and when same data is requested so frequently from server then the quantity of transmitted data from web server device (21) increases which causes bottleneck of traffic and consumes a lot of time so that user's reciprocal process can not function smoothly therefore this invention is to complement such problems.

In order to synthesize human synthesis on client system device (10), when there are renewed contents of internet connected contents database (27) of server system device (20) then updates the renewed contents or updated program will be pushed by patch file to database (14) of client system device (10) to update when server system device (20) of client system device (10) is in position of online on internet.

### BRIEF DESCRIPTION OF THE DRAWINGS

FIG. 1 is entire block drawing of formation of this invention.

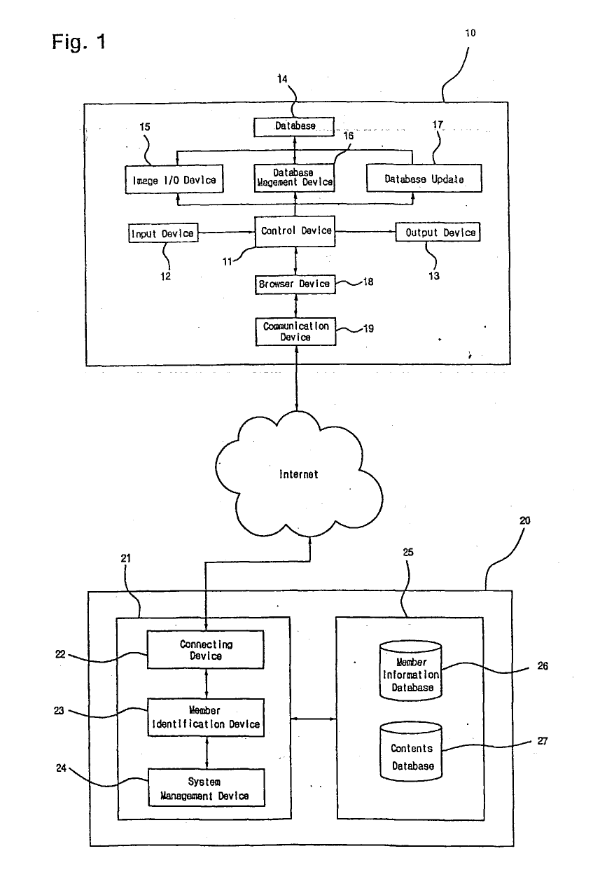

FIG. 2 is an illustration of flowchart of human synthesis on client system device that applies to this invention.

FIG. 3 is an illustration of flowchart of human synthesis on server system device that applies to this invention.

*Symbol explanation of principal part of drawing*

10. Client System Device
11. Control System Device
12. Input Device
13. Output Device
14. Database
15. Image Output Device
16. Database Management Device
17. Database Update Device
18. Browser Device
19. Communication Device
20. Server System Device
21. Web Server Device
22. Interface Device
23. Member Certification Device
24. System Management Device
25. Database Server Device
26. Member Information Database Device
27. Contents Database Device

### EXAMPLES

This invention is constructed as above and the following is service-providing process.

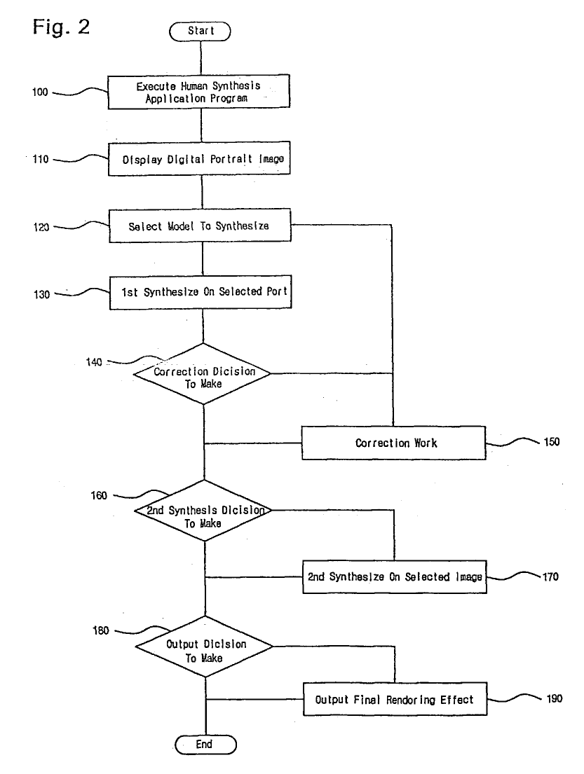

FIG. 2 is an illustration of flowchart of human synthesis on client system device (10) that applies to this invention.

Basically users should set up the human synthesis application program and necessary human synthesis contents that classified by items and fields stored on database of personal computer or kiosk system that can execute the human synthesis application program. (100)

Running this human synthesis application program, basic environment sets up for human synthesis of digital image form that can be worked on output device (13), monitor, users can take pictures with digital camera and digital portrait image or scanned is digital portrait image or portrait image of analog system camera that transfer to digital portrait image to input to input device (12). (110)

Portrait image input method of input device (12) that inputs digital portrait image and displays through control device on monitor by output device (13). In order to display digital portrait image of user on the monitor, the portrait image input method can be used but users can display self-image extract from database (14) and also users can display self digital portrait image that stored when they applied for membership.

When portrait image of user displays on monitor, user want to display the information of object model that is stored on database(14) for mixing and the data of model will be selected (120) through database management device (16) and control device (11) will control the image that will display on monitor through output device (15).

Displaying the digital portrait image of user and digital portrait image of model then mix user and model portrait (130) on monitor, the output device (13). Left button of mouse, the input device (12), put on portrait of user and drag it to form the portrait of ready to mix and select mix button on the model then on the portrait of model, users' face will be rendered real-time.

User cannot recognize the mixing process with eye but rendered effect can be recognized. User will select the form of face of self digital portrait image for mix then color control (RGB), boundary treatment and correction, intensity of light and color adjustment, delete and smooth over the boundary level and mix new layer, special effect, unfinished treatment of human synthesis, all these in real-time combinations of process will work through human synthesis application program that user can see in real time effects after rendered.

The rendered effects displayed on monitor, user will decide whether revise the effect (140). When the result of render is not enough for the user, simple revise process can apply on effect (150). User can repeat the mixing process through searching the database (14) and display selected model on monitor from database management device (16) and output device (15).

The effect is good enough for user then on the digital composed image user will decide whether secondary editing process with special effects like hairstyle, accessory, fashion, makeup, etc. will add on. (160)

For mixing process user will search the database (14) and take the needed data. The data is primarily finished digital portrait through database management device (16) and image output device (15). Display the digital portrait image on monitor where processing job takes place and mix self portrait with variety of contents on imaginary space. (170)

The human synthesis process is clone as user desired. User will decide whether output the finished image. (180) If decide to output user can print the image on computer printer or photo printer through output device (190) and when user would not output the image, it can be stored on database (14) or store the image on internet connected contents database device (27) of server system device (20).

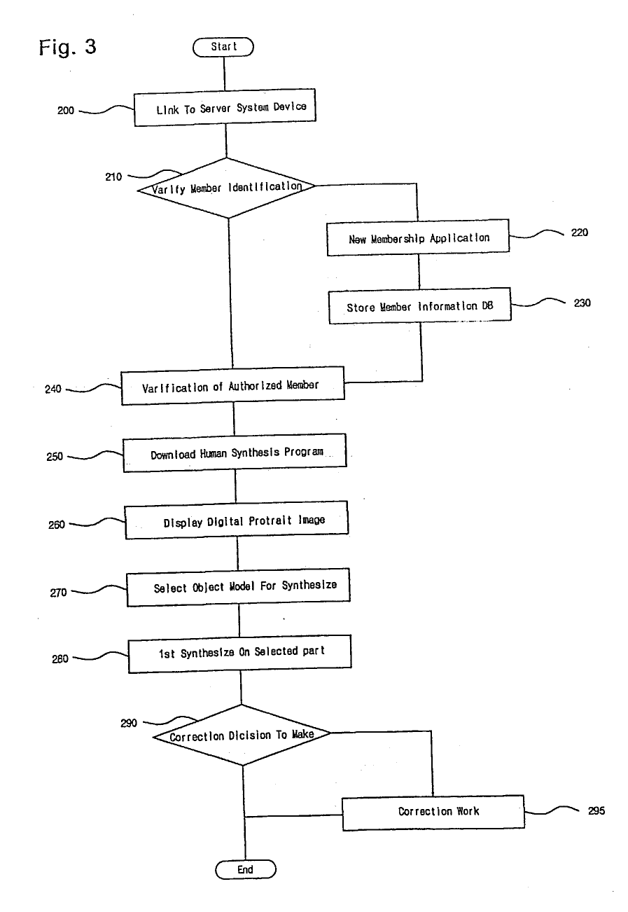

FIG. 3 is an illustration of flowchart of human synthesis on server system device (20) that applies to this invention.

The users of client system device (10) will input the server domain or Internet Protocol through input device (12). The server domain or IP will be transmitted to member certification device (23) through browser device (18) to connect to link device (22) of web server device (21). (200) Input the server domain or IP address on member certification device (23) where users input their identification and password on start screen. Users will death play on monitor, output device of client system device (10) through browser device (18).

After inputting ID and password on input device (12) of client system device (10) through the browser (18), it transmits to web server device (21). Member certification device (23) will verify information through the run script of system device (24) whether user is registered member with transmitted ID and password link with member management database device (26). (210)

If transmitted ID and password is not authorized user of this invention, user must take new membership application process (220). Member certification device (23) will transmit web page for new applicant and establish ID and password of user and personal information through the browser device (18) of client system device (10). User will fill out personal information on received web page and input on web server device (21) through browser device (18).

The newly established ID and password and personal information on web server device (21), applicant information will be transmitted to member information database device (26) and store (230) through member certification device (23) to authorize. (240)

Authorized member can work on human synthesis application program that is installed on web server device (21). Using this program, display digital portrait image on monitor of client system device (10) where basic program environment is installed that users can mix images. Generally human synthesis application program that is executed on web server device (21) is demonstration version, which restricts to use some function.

Executed demonstration version of human application program from web server device (21) which explains on drawing 2, it will take same procedure as that executed on client system device (10). Function wise, some restriction is applied that users can only work on limited services provided and in order to recognize demonstration version on client system device, one can download from a website where service provided for human synthesis program that users can work on. (250)

The demonstration of human synthesis demonstration version on web server device (21), authorized user can input the portrait image through input method of client system device (10). Search the digital portrait image from contents database device (27) and display the searched contents on monitor. (260)

A desired model that user plan to compose, search the contents database device (27) and select a model. After selecting a model, display digital portrait image of model on monitor, the output device (13), using browser device (18) of client system device (10) on system management device (23) of web server device (21). (270)

Digital portrait image of user will compose with digital portrait image of model displayed on monitor, the output device (13) that explained on drawing 2, composite face of user over model face. (280)

User will decide to correct the displayed effects of render on monitor, input device (12) after seeing it (290), if rendered effect is not desirable for the user, it can be corrected with simple process (295) or go back to database and search a new model and repeat the process.

The rendered effect of portrait image that has been done through all the process, variety of image can be added on the effect. But limit to users to use rendering functions, such as hairstyle, accessory, fashion, makeup, etc. and instead let users purchase or download the human synthesis application program separately.

Users can work on personal computer or kiosk system that is constructed with human synthesis application program and contents database of this invention. General users can use the program with simple operation on human synthesis and output the effect. This invention can be used at beauty parlor, fashion shop, wig shop, cosmetic makeup shop, plastic surgery, and etc. where users can render self-image.

This invention is not limited to substitution, transformation, and modification with in the basic knowledge of attached drawings and explained examples.

### THE POSSIBILITY OF INDUSTRIALIZATION

On personal computer or kiosk system that is constructed with human synthesis application program and contents database general users can use the program with simple operation on human synthesis. The rendered effect can be stored on designated data input device and can be printed on photo printer or equivalent equipment that users can see altered self-portrait in advance. Users can render the image for the best effect on self-image. Therefore this invention is useful for the beauty parlor, wig shop, cosmetic shop, fashion shop, plastic surgery, etc. The sticker photo is popular these days, like sticker photo, using kiosk system, user can adorn and makeup on self image without separate cosmetics and outfitting and create a distinctive personality.

What is claimed is:

1. A system by using the internet to offer the human synthesis modeling, said system comprising;
the formation divide into client system and server system, said client system comprise as follows,
control component controlling various computer peripherals connected to computer;
input component dividing into that the portrait image-input means putting digital image on computer monitor and command-input means operating with a mouse or keyboard to work human synthesis on displayed image on monitor;
output component, outputting command word that users can recognize from input means;
database component providing necessary data for human synthesis work that is classified by item and field and when user request for data in on-line;
database management component storing to classify the data said in database and outputting the data when users request data;
database update component inputting the data to transmit from server system that is connected to Internet;
portrait image input and output component having function of stored data on database that can output the portrait image on monitor that user can recognize and necessary image data for image processing work that can store with designated form;
browser component searching all files on Internet, displaying on monitor that user can recognize the file;
communication component transmitting with client system and server system a data each other;
said server system comprise web server and database server, said web server comprising as follows, link component connecting from client system to server system through internet;
member identification component authorizing user of connecting said link component;
system management component controlling that input command word of user transmitted from client system, operate the script to extract and to store data of database server of executing said command word;
said database server comprising as follows, member information database component storing information of member to verify server system linked user whether authorized member;
contents database component storing to classifies data by item and field of providing image composition services to internet connected user through on-line.

2. The system according to claim 1, wherein said the client system using personal computer install human synthesis application program on computer and work on human synthesis, updating contents updates from server system to client system through internet.

3. The system according to claim 1, wherein said client system using kiosk system establish at a designated public place where user can work on human synthesis free and easy, updating contents updates from server system to client system through internet.

4. The system according to claim 1, wherein when there is renewing contents on contents database component of server system, client system and server system that link to internet and maintain on-line status, then the updated contents or program is pushed to database of client system by patch file to update.

5. A method by using the internet to offer the human synthesis modeling, comprising the steps of;
Step 1. displaying subject of digital portrait image on computer monitor, then
Step 2. searching the digital portrait image from that stored on database and displaying the object to work on, and then
Step 3. compositing the selected part that specify synthetic part in digital portrait image of the synthetic subject in first, and then
Step 4. diciding whether or not to modify about the rendered effect, and then
Step 5. compositing additional image in second on the rendered effect of digital synthesis image, and then
Step 6. through all these steps, storing final rendered effect and outputting with designated displaying component.

6. A method according to claim 5, wherein said at first step, using digital camera, a digital portrait image of subject that will synthesize display in a computer of client system.

7. A method according to claim 5, wherein said at first step, using scanner, a digital portrait image of subject that will synthesize display on a computer of client system.

8. A method according to claim 5, wherein said at first step, a digital portrait image of subject that will synthesize display on a computer of client system, to extract image data of storing on database.

9. A method by using the internet to offer the human synthesis modeling, comprising the steps of;
Step 1. connecting from client system to server system through brower component, then
Step 2. vesting authority in user that connect to server system from member identification component, and then
Step 3. downloading the human synthesis program that can recognize human synthesis application program from server system to client system, and then
Step 4. displaying a digital portrait image of subject that will synthesize on monitor of computer, and then
Step 5. searching a digital portrait image of object that will synthesize of storing on contents database of server system, displaying it on computer monitor, and then
Step 6. compositing the selected part that specify synthetic part in digital portrait image of the synthetic subject, and then
Step 7. diciding whether or not to modify about the renderde effect.
